(19) United States
(12) Patent Application Publication
(10) Pub. No.: US 2023/0121264 A1
(43) Pub. Date: Apr. 20, 2023

(54) HEAD CHIP, LIQUID JET HEAD, LIQUID JET RECORDING DEVICE, AND METHOD OF MANUFACTURING HEAD CHIP

(71) Applicant: Sll Printek Inc., Chiba-shi (JP)

(72) Inventors: Tooru MINE, Chiba-shi (JP); Yuki Yamamura, Chiba-shi (JP)

(21) Appl. No.: 17/963,808

(22) Filed: Oct. 11, 2022

(30) Foreign Application Priority Data
Oct. 14, 2021 (JP) 2021-168619

(51) Int. Cl. B41J 2/14; B41J 2/16

(52) U.S. Cl. CPC B41J 2/14274; B41J 2/1612; B41J 2/1623

(57) ABSTRACT

There are provided a head chip, a liquid jet head, a liquid jet recording device, and a method of manufacturing a head chip each capable of homogenously forming protective films on inner surfaces of channels while dealing with miniaturization of the channels and a decrease in pitch of the channels. The head chip according to an aspect of the present disclosure includes an actuator plate having a plurality of ejection channels arranged, a common electrode formed on an inner surface of the ejection channel, a first protective film disposed so as to cover the common electrode on the inner surface of the ejection channel, an intermediate plate which has ejecting communication holes and ejection-side introduction ports respectively communicated with the plurality of ejection channels, and which is disposed so as to face a channel opening surface on which the ejection channels open in the actuator plate, and a nozzle plate which has a plurality of nozzle holes configured to eject ink, and which is disposed at an opposite side to the actuator plate with respect to the intermediate plate in a state in which the ejecting communication holes are respectively communicated with the nozzle holes, and the ejection-side introduction ports are closed.

### RELATED APPLICATIONS

This application claims priority to Japanese Patent Application No. 2021-168619, filed on October 14, 2021, the entire content of which is incorporated herein by reference.

### BACKGROUND OF THE INVENTION

### 1. Field of the Invention

The present disclosure relates to a head chip, a liquid jet head, a liquid jet recording device, and a method of manufacturing a head chip.

### 2. Description of the Related Art

A head chip to be installed in an inkjet printer is provided with an actuator plate having a plurality of channels, and a nozzle plate bonded to the actuator plate. The nozzle plate is provided with a plurality of nozzle holes respectively communicated with the plurality of channels. In the actuator plate, electrodes are formed on inner surfaces of the channels. As shown in JP-A-2010-214895 (Patent Literature 1), on the inner surfaces of the channels, there are formed protective films having an insulation property. According to this configuration, since the electrodes are covered with the protective films, it is conceivable that it is possible to prevent the electrodes from shorting via ink inside the channel even when using conductive ink.

In recent years, due to miniaturization of the channels and a decrease in pitch of the channels, the tolerance of a displacement between the actuator plate (the channels) and the nozzle plate (the nozzle holes) has decreased. For example, when a bonding position of the nozzle plate with respect to the actuator plate is shifted in an arrangement direction of the channels, there is a possibility of leading to a deterioration of ejection characteristics and a leakage of the ink.

In JP-A-2019-42979 (Patent Literature 2), there is disclosed a configuration in which an intermediate plate is disposed between the actuator plate and the nozzle plate. The intermediate plate is provided with communication holes communicated with both of the channels and the nozzle holes. The communication holes are formed to be larger than the channels and the nozzle holes in the arrangement direction of the channels. According to this configuration, it is conceivable that it is possible to increase the tolerance of the displacement between the channels and the nozzle holes by making the channels and the nozzle holes communicate with each other through the communication holes compared to when making the channels and the nozzle holes directly communicate with each other.

In order to ensure the positional accuracy between the communication holes and the channels in the configuration of adopting the intermediate plate, it is conceivable that it is preferable to form the communication holes after bonding the intermediate plate to the actuator plate.

In this case, in related art technologies, it is difficult to effectively introduce a formation material of the protective films into the channels through the communication holes. As a result, there is a possibility that there occurs a place where the film thickness of the protective film cannot sufficiently be ensured on the inner surfaces of the channels.

In contrast, when forming the protective films before bonding the intermediate plate to the actuator plate, there is a possibility that the protective films are damaged when penetrating the intermediate plate to form the communication holes after bonding the intermediate plate to the actuator plate.

The present disclosure provides a head chip, a liquid jet head, a liquid jet recording device, and a method of manufacturing a head chip each capable of homogenously forming the protective films on the inner surfaces of the channels while dealing with the miniaturization of the channels and the decrease in pitch of the channels.

### SUMMARY OF THE INVENTION

In view of the problems described above, the present disclosure adopts the following aspects.

(1) A head chip according to an aspect of the present disclosure includes an actuator plate in which a plurality of jet channels extending in a first direction is arranged in a second direction crossing the first direction, a first electrode formed on an inner surface of the jet channel, a first protective film disposed so as to cover the first electrode on the inner surface of the jet channel, an intermediate plate which has first communication holes and second communication holes respectively communicated with the plurality of jet channels, and which is disposed so as to face a channel opening surface on which the jet channels open in the actuator plate, and a jet hole plate which has a plurality of jet holes configured to jet liquid, and which is disposed at an opposite side to the actuator plate with respect to the intermediate plate in a state in which the first communication holes are respectively communicated with the jet holes, and the second communication holes are closed.

According to the present aspect, when forming the first protective films in the jet channels in the state in which the intermediate plate is disposed, it is possible to introduce the formation material of the first protective films through the second communication holes in addition to the first communication holes. Thus, it is easy to homogenously form the first protective films in the jet channels.

In this case, it is possible to prevent the damage from being inflicted on the first protective films and so on when forming the first communication holes compared to when bonding the intermediate plate to the actuator plate provided with the first protective films, and then forming the first communication holes as post-processing.

As a result, it is possible to homogenously form the first protective films on the inner surfaces of the jet channels to protect the first electrodes while dealing with the miniaturization of the jet channels and the reduction in pitch of the jet channels.

(2) In the head chip according to the aspect (1) described above, it is preferable that the channel opening surface faces to a first side in a third direction crossing the second direction when viewed from the first direction in the actuator plate, a cover plate having a liquid flow channel communicated with the jet channels is disposed on a surface facing to a second side as an opposite side to the first side in the third direction in the actuator plate, and the second communication holes are each communicated with the jet channel in a portion located between the liquid flow channel and the first communication hole in the first direction.

When forming the first protective films in the state in which the cover plate and the intermediate plate are stacked on one another, the formation material of the first protective films is introduced into the jet channels through the first communication holes and the liquid flow channels when the second communication holes are not formed. On this occasion, in the jet channels, it is difficult for the first protective film to reach an intermediate portion between the first communication hole and the liquid flow channel. Therefore, in the jet channels, it is difficult for the intermediate portion between the first communication hole and the liquid flow channel to ensure the film thickness of the first protective film as a film thickness minimum portion.

Therefore, by disposing the second communication hole in the portion located between the liquid flow channel and the first communication hole in the first direction as in the present aspect, it is possible to increase the film thickness in the film thickness minimum portion. Therefore, it is possible to homogenously form the first protective films on the inner surfaces of the jet channels.

(3) In the head chip according to the aspect (2) described above, it is preferable that the jet channels each include a penetrating part opening on the channel opening surface in a central portion in the first direction, and an uprise part which is communicated with at least a first side end portion in the first direction with respect to the penetrating part, and which decreases in depth in the third direction as getting away from the central portion, the liquid flow channel is communicated with the jet channel at a position overlapping the uprise part when viewed from the third direction, and the second communication holes are each located at a side of the liquid flow channel with respect to a center in the first direction in an area between the liquid flow channel and the first communication hole.

For example, the uprise part is a place where the flow channel cross-sectional area of the jet channel is small compared to the penetrating part, and the pressure loss becomes relatively high. Therefore, when introducing the formation material of the first protective films through the first communication holes, the formation material of the first protective film is difficult to pervade the portion.

In view of the above, according to the present aspect, by disposing the second communication holes at the liquid flow channel side with respect to the center, it is possible to more surely form the first protective film to the film thickness minimum portion.

(4) In the head chip according to any of the aspects (1) through (3) described above, it is preferable that a dimension in the second direction in the second communication hole is set no larger than a dimension in the second direction in the jet channel.

According to the present aspect, even when forming the second communication holes as post-processing after bonding the intermediate plate and the actuator plate to each other, it is possible to prevent the damage from being inflicted on the actuator plate when processing the second communication holes.

(5) the head chip according to any of the aspects (1) through (4) described above, it is preferable that the second communication holes are each formed to have a circular shape when viewed from an opening direction of the second communication hole.

According to the present aspect, since a corner part is not formed on the inner surfaces of the second communication holes, it is possible to prevent retention of bubbles in the second communication holes. By preventing the retention of the bubbles, it is possible to prevent the bubbles from being discharged from the jet holes when jetting the liquid. As a result, it is possible to prevent a printing failure such as white slip to thereby perform high-precision printing.

(6) In the head chip according to any of the aspects (1) through (5) described above, it is preferable that in an inner surface of the second communication hole, a dimension between portions opposed to each other is twice or more as large as a film thickness of the first protective film to be formed in the jet channel.

According to the present aspect, it is possible to prevent the second communication holes from being closed by the first protective films to be attached to the inner surfaces of the second communication holes before the completion of the introduction of the first protection films into the jet channels when forming the first protective films. As a result, it is possible to surely introduce the formation material of the first protective film into the jet channels.

(7) In the head chip according to any of the aspects (1) through (6) described above, it is preferable that the jet hole plate is bonded to the intermediate plate via an adhesive, and a part of the adhesive is housed in the second communication holes.

According to the present aspect, it is possible to prevent the superfluous adhesive from reaching the first communication holes and the jet holes when bonding the jet hole plate and the intermediate plate to each other. As a result, it is possible to prevent the liquid flow from being hindered by the adhesive to thereby prevent the ejection performance from deteriorating.

Further, since it is possible to reduce an effective volume of the first communication holes after forming the protective films, it is possible to prevent the bubbles from being retained in the second communication holes when using the head chip. By preventing the retention of the bubbles, it is possible to prevent the bubbles from being discharged from the jet holes when jetting the liquid. As a result, it is possible to prevent a printing failure such as white slip to thereby perform high-precision printing.

(8) In the head chip according to any of the aspects (1) through (7) described above, it is preferable to further include a non-jet channel which is formed in a portion located between the jet channels adjacent to each other in the second direction in the actuator plate, and which is not filled with the liquid, a second electrode formed on an inner surface of the non-jet channel, and a second protective film disposed so as to cover the second electrode on the inner surface of the non-jet channel, wherein the intermediate plate is provided with a third communication hole communicated with the non-jet channel.

According to the present aspect, it is possible to introduce the formation material of the second protective films into the non-jet channels through the third communication hole. Therefore, it is easy to homogenously form the second protective films in the non-jet channels.

(9) In the head chip according to the aspect (8) described above, it is preferable that the non-jet channel opens on an end surface facing to a first side in the first direction in the actuator plate, and the third communication hole is communicated with the non-jet channel in an end portion at a second side as an opposite side to the first side in the first direction in the non-jet channel.

When forming the second protective films in the state in which the cover plate and the intermediate plate are stacked on one another, the formation material of the second protective films is introduced into the non-jet channels through the end surface opening part formed on the end surface facing to the first side in the first direction in the actuator plate when the third communication hole is not formed. On this occasion, in the non-jet channels, it is difficult for the second protective film to reach the end portion located at the second side in the first direction. Therefore, in the non-jet channels, it is difficult for the end portion located at the second side in the first direction to ensure the film thickness of the second protective film as the film thickness minimum portion.

According to the present aspect, by disposing the third communication hole in the end portion located at the second side in the first direction in the non-jet channel, it is possible to form the second protective film in the film thickness minimum portion.

(10) In the head chip according to one of the aspects (8) and (9) described above, it is preferable that the non-jet channel includes a protruding part protruding in the first direction from the channel opening part opening on the channel opening surface in the jet channel, and the third communication hole extends in the second direction traversing between the protruding parts of the non-jet channels adjacent to each other in the second direction, and is collectively communicated with the non-jet channels adjacent to each other through the protruding parts.

According to the present aspect, it is possible to share the third communication hole with the non-jet channels adjacent to each other. Therefore, it is possible to increase the manufacturing efficiency compared to the configuration in which the third communication hole is disposed for each of the non-jet channels adjacent to each other.

(11) A liquid jet head according to an aspect of the present disclosure includes the head chip according to any of the aspects (1) through (10) described above.

According to the present aspect, since the head chip according to the aspect described above is provided, it is possible to provide the liquid jet head high in quality and excellent in reliability.

(12) A liquid jet recording device according to an aspect of the present disclosure includes the liquid jet head according to the aspect (11) described above.

According to the present aspect, it is possible to provide a liquid jet recording device high in quality and excellent in reliability.

(13) A method of manufacturing a head chip according to an aspect of the present disclosure is a method of manufacturing a head chip including an actuator plate in which a plurality of jet channels extending in a first direction is arranged in a second direction crossing the first direction, a first electrode formed on an inner surface of the jet channel, a first protective film disposed so as to cover the first electrode on the inner surface of the jet channel, and an intermediate plate disposed so as to be opposed to a channel opening surface on which the jet channels open in the actuator plate, the method including a communication hole formation step of forming first communication holes and second communication holes respectively communicated with the plurality of jet channels to the intermediate plate, a protective film formation step of forming the first protective film in the jet channels through the first communication holes and the second communication holes in a state in which the intermediate plate is stacked on the actuator plate, and a jet hole plate stacking step of stacking a jet hole plate having a plurality of jet holes configured to jet liquid on the intermediate plate so that the first communication holes are respectively communicated with the jet holes, and the second communication holes are closed with the jet hole plate.

(14) In the method of manufacturing the head chip according to the aspect (13) described above, it is preferable to further include an intermediate plate stacking step of stacking the intermediate plate on the actuator plate before the protective film formation step, wherein the communication hole formation step includes a first communication step of providing the first communication holes to the intermediate plate after the intermediate plate stacking step, and a second communication step of providing the second communication holes to the intermediate plate before the intermediate plate stacking step.

According to the present aspect, by forming the second communication holes in advance of the intermediate plate stacking step, it is possible to shorten the processing time after stacking the intermediate plate until the head chip is completed.

(15) In the method of manufacturing the head chip according to the aspect (13) described above, it is preferable to further include an intermediate plate stacking step of stacking the intermediate plate on the actuator plate before the protective film formation step, wherein the communication hole formation step is performed between the intermediate plate stacking step and the protective film formation step.

According to the present aspect, by forming the first communication holes and the second communication holes in the state in which the intermediate plate is stacked on the actuator plate, it is possible to increase the positional accuracy between the jet channels, and the first communication holes and the second communication holes.

(16) In the method of manufacturing the head chip according to any of the aspects (13) through (15) described above, it is preferable that the head chip further includes a non-jet channel which includes a protruding part protruding in the first direction from a channel opening part opening on the channel opening surface in the jet channel, and which is formed in a portion located between the jet channels adjacent to each other in the second direction in the actuator plate, and which is not filled with the liquid, a second electrode formed on an inner surface of the non-jet channel, and a second protective film disposed so as to cover the second electrode on the inner surface of the non jet channel, and the method further includes a third communication step of forming a third communication hole which extends in the second direction traversing between the protruding parts of the non-jet channels adjacent to each other in the second direction in the intermediate plate, and is collectively communicated with the non-jet channels adjacent to each other through the protruding parts, and an intermediate plate stacking step of stacking the intermediate plate provided with the third communication hole on the actuator plate before the protective film formation step.

According to the present aspect, by forming the third communication hole in advance, it is possible to shorten the processing time after stacking the intermediate plate until the head chip is completed.

According to an aspect of the present disclosure, it is possible to homogenously form the protective films on the inner surfaces of the channels while dealing with the miniaturization of the channels and the decrease in pitch.

### BRIEF DESCRIPTION OF THE DRAWINGS

FIG. 1 is a schematic configuration diagram of an inkjet printer according to a first embodiment.

FIG. 2 is a schematic configuration diagram of an inkjet head and an ink circulation mechanism according to the first embodiment.

FIG. 3 is a perspective view of a head chip according to the first embodiment viewed from a −Z side in a state in which a nozzle plate is detached.

FIG. 4 is an exploded perspective view of the head chip according to the first embodiment.

FIG. 5 is a bottom view of an actuator plate according to the first embodiment.

FIG. 6 is a cross-sectional view corresponding to a line VI-VI shown in FIG. 5.

FIG. 7 is a cross-sectional view corresponding to a line VII-VII shown in FIG. 5.

FIG. 8 is a cross-sectional view along a line VIII-VIII shown in FIG. 4.

FIG. 9 is an enlarged view of FIG. 6.

FIG. 10 is a flowchart for explaining a method of manufacturing the head chip according to the first embodiment.

FIG. 11 is a diagram for explaining a step of the method of manufacturing the head chip according to the first embodiment, and is a cross-sectional view corresponding to FIG. 6.

FIG. 12 is a diagram for explaining a step of the method of manufacturing the head chip according to the first embodiment, and is a cross-sectional view corresponding to FIG. 6.

FIG. 13 is a diagram for explaining a step of the method of manufacturing the head chip according to the first embodiment, and is a cross-sectional view corresponding to FIG. 6.

FIG. 14 is a bottom view corresponding to FIG. 5 in a head chip according to a second embodiment.

### DETAILED DESCRIPTION OF THE PREFERRED EMBODIMENTS

Some embodiments according to the present disclosure will hereinafter be described with reference to the drawings. In the embodiments and modified examples described hereinafter, constituents corresponding to each other are denoted by the same reference symbols to omit the description thereof in some cases. It should be noted that in the following description, expressions representing relative or absolute arrangement such as “parallel,” “perpendicular,” “center,” and “coaxial” not only represent strictly such arrangements, but also represent the state of being relatively displaced with a tolerance, or an angle or a distance to the extent that the same function can be obtained. In the following embodiments, the description will be presented citing an inkjet printer (hereinafter simply referred to as a printer) for performing recording on a recording target medium using ink (liquid) as an example. It should be noted that the scale size of each member is arbitrarily modified so as to provide a recognizable size to the member in the drawings used in the following description.

### [Printer 1]

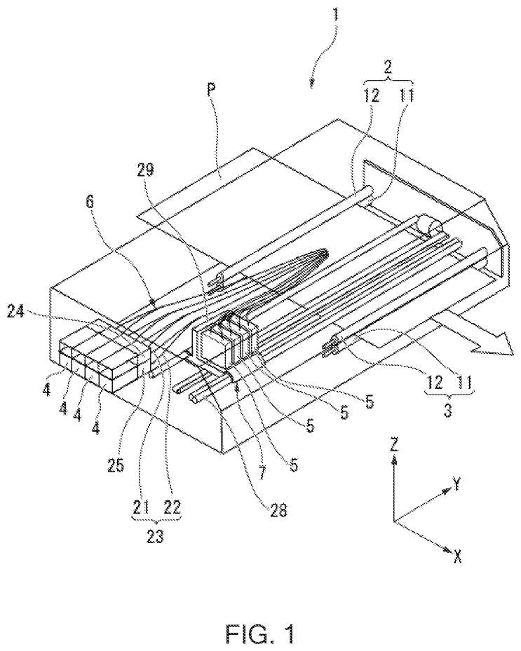

FIG. 1 is a schematic configuration diagram of the printer 1.

The printer (a liquid jet recording device) 1 shown in FIG. 1 is provided with a pair of conveying mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, the X direction coincides with the conveying direction (a sub-scanning direction) of a recording target medium P (e.g., paper). The Y direction coincides with a scanning direction (a main scanning direction) of the scanning mechanism 7. The Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the present specification, the +Z side corresponds to an upper side in the gravitational direction, and the −Z side corresponds to a lower side in the gravitational direction.

The conveying mechanisms 2, 3 convey the recording target medium P toward the +X side. The conveying mechanisms 2, 3 each include a pair of rollers 11, 12 extending in, for example, the Y direction.

The ink tanks 4 respectively contain four colors of ink such as yellow ink, magenta ink, cyan ink, and black ink. The inkjet heads 5 are configured so as to be able to respectively eject the four colors of ink, namely the yellow ink, the magenta ink, the cyan ink, and the black ink in accordance with the ink tanks 4 coupled thereto.

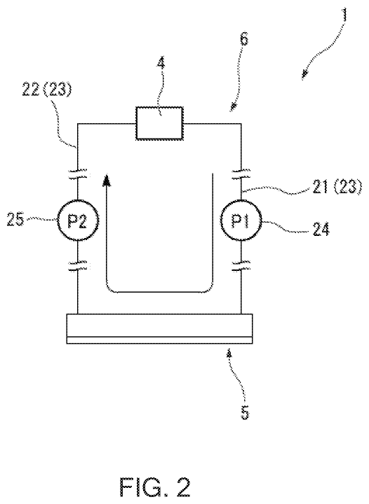

FIG. 2 is a schematic configuration diagram of the inkjet head 5 and the ink circulation mechanism 6.

As shown in FIG. 1 and FIG. 2, the ink circulation mechanism 6 circulates the ink between the ink tank 4 and the inkjet head 5. Specifically, the ink circulation mechanism 6 is provided with a circulation flow channel 23 having an ink supply tube 21 and an ink discharge tube 22, a pressure pump 24 coupled to the ink supply tube 21, and a suction pump 25 coupled to the ink discharge tube 22.

The pressure pump 24 pressurizes the inside of the ink supply tube 21 to deliver the ink to the inkjet head 5 through the ink supply tube 21. Thus, the ink supply tube 21 is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 is provided with negative pressure with respect to the inkjet head 5. It is arranged that the ink can circulate between the inkjet head 5 and the ink tank 4 through the circulation flow channel 23 by driving the pressure pump 24 and the suction pump 25.

As shown in FIG. 1, the scanning mechanism 7 reciprocates the inkjet heads 5 in the Y direction. The scanning mechanism 7 is provided with a guide rail 28 extending in the Y direction, and a carriage 29 movably supported by the guide rail 28.

### <Inkjet Heads 5>

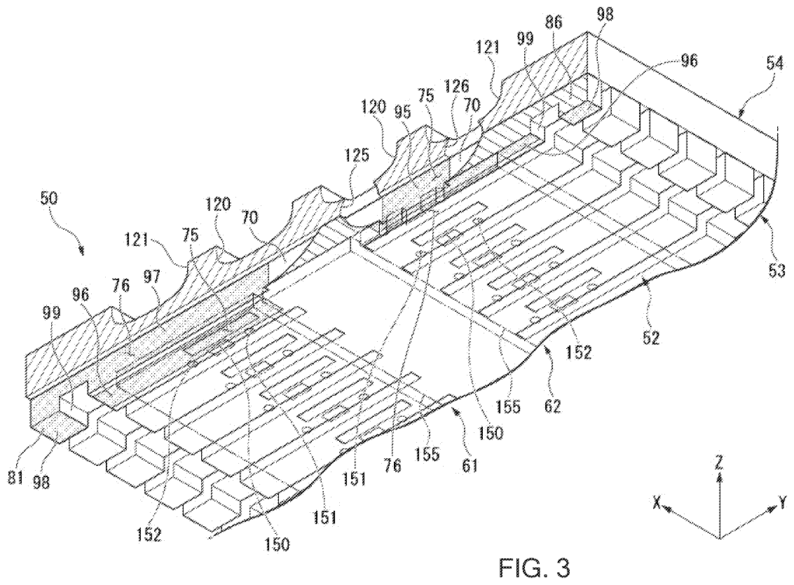

The inkjet heads 5 are mounted on the carriage 29. In the illustrated example, the plurality of inkjet heads 5 is mounted on the single carriage 29 so as to be arranged side by side in the Y direction. The inkjet heads 5 are each provided with a head chip 50 (see FIG. 3), an ink supply section (not shown) for coupling the ink circulation mechanism 6 and the head chip 50, and a control section (not shown) for applying a drive voltage to the head chip 50.

### <Head Chip 50>

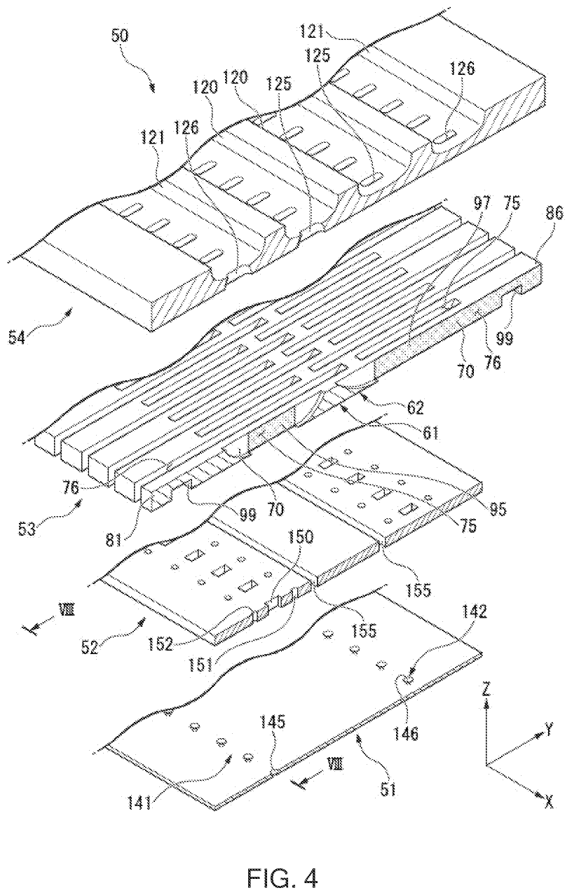

FIG. 3 is a perspective view of the head chip 50 viewed from the −Z side in the state in which a nozzle plate 51 is detached. FIG. 4 is an exploded perspective view of the head chip 50.

The head chip 50 shown in FIG. 3 and FIG. 4 is a so-called circulating side-shooting type head chip 50 which circulates the ink with the ink tank 4, and at the same time, ejects the ink from a central portion in the extending direction (the Y direction) in an ejection channel 75 described later. The head chip 50 is provided with the nozzle plate 51 (see FIG. 4), an intermediate plate 52, an actuator plate 53, and a cover plate 54. The head chip 50 is provided with a configuration in which the nozzle plate 51, the intermediate plate 52, the actuator plate 53, and the cover plate 54 are stacked on one another in this order in the Z direction. In the following explanation, the description is presented in some cases defining a direction (+Z side) from the nozzle plate 51 toward the cover plate 54 along the Z direction (a third direction) as an upper side (a second side in the third direction), and a direction (−Z side) from the cover plate 54 toward the nozzle plate 51 along the Z direction as a lower side (a first side in the third direction).

The actuator plate 53 is formed of a piezoelectric material such as PZT (lead zirconate titanate). The actuator plate 53 is a so-called chevron substrate formed by, for example, stacking two piezoelectric plates different in polarization direction in the Z direction on one another. It should be noted that the actuator plate 53 can be a so-called monopole substrate in which the polarization direction is unidirectional throughout the entire area in the Z direction.

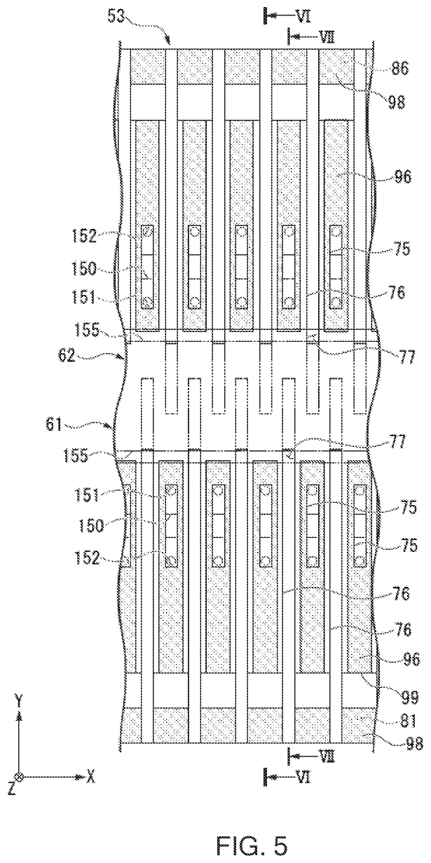

FIG. 5 is a bottom view of the actuator plate 53.

As shown in FIG. 4 and FIG. 5, the actuator plate 53 is provided with a plurality of (e.g., two) channel columns 61, 62. In the present embodiment, the channel columns 61, 62 correspond to a first channel column 61 and a second channel column 62. The channel columns 61, 62 extend in the X direction, and at the same time, are arranged at a distance in the Y direction.

The configuration of the channel columns 61, 62 will hereinafter be described citing the first channel column 61 as an example.

The first channel column 61 has the ejection channels (jet channels) 75 filled with the ink, and non-ejection channels (non-jet channels) 76 not filled with the ink. The channels 75, 76 each extend linearly in the Y direction (a first direction), and at the same time, are alternately arranged side by side at intervals in the X direction (a second direction) in a plan view viewed from the Z direction. In the actuator plate 53, a portion located between the ejection channel 75 and the non-ejection channel 76 constitutes a drive wall 70 (see FIG. 4) which partitions the ejection channel 75 and the non-ejection channel 76 from each other in the X direction. It should be noted that the configuration in which the channel extension direction coincides with the Y direction will be described in the present embodiment, but the channel extension direction can cross the Y direction.

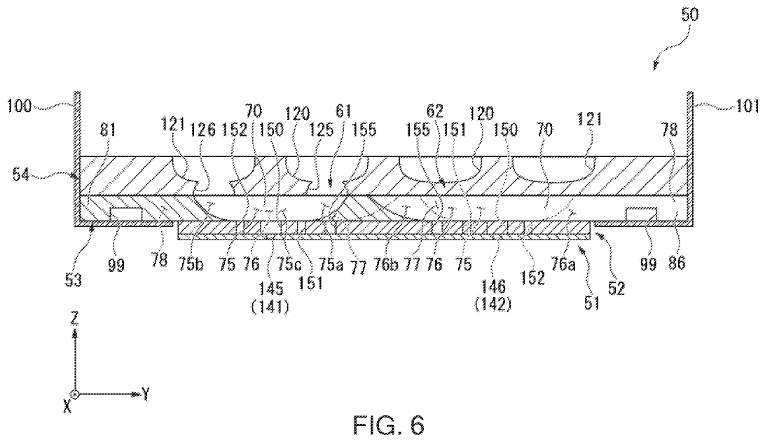

FIG. 6 is a cross-sectional view corresponding to a line VI-VI shown in FIG. 5.

As shown in FIG. 6, the ejection channel 75 is formed to have a circular arc shape convex downward in a side view viewed from the X direction. The ejection channels 75 are formed by, for example, making a dicer having a disk-like shape enter the actuator plate 53 from above (the +Z side) the actuator plate 53. Specifically, the ejection channels 75 each have a first uprise part 75a located in a +Y-side end portion, a second uprise part 75b located in a -Y-side end portion, and an ejection-side penetrating part 75c located between the uprise parts 75a, 75b.

The uprise parts 75a, 75b each have a circular arc shape constant in curvature radius viewed from the X direction. The uprise parts 75a, 75b each decrease in depth in the Z direction as getting away from the ejection-side penetrating part 75c in the Y direction.

The ejection-side penetrating part 75c penetrates the actuator plate 53 in the Z direction in a central portion in the Y direction in the ejection channel 75. Therefore, the ejection channel 75 has an upper-side opening part in which the whole (the uprise parts 75a, 75b and the ejection-side penetrating part 75c) of the ejection channel 75 opens on an upper surface of the actuator plate 53, and a lower-side opening part (a channel opening part) in which only the ejection-side penetrating part 75c opens on a lower surface (a channel opening surface) of the actuator plate 53.

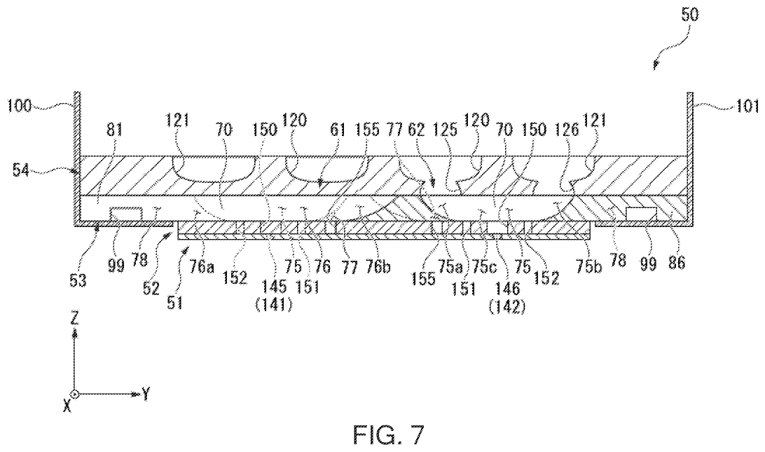

FIG. 7 is a cross-sectional view corresponding to a line VII-VII shown in FIG. 5.

As shown in FIG. 7, the non-ejection channel 76 is adjacent to the ejection channel 75 across the drive wall 70 in the X direction. The non-ejection channels 76 are formed by, for example, making a dicer having a disk-like shape enter the actuator plate 53 from above the actuator plate 53. The non-ejection channel 76 is provided with a non-ejection-side penetrating part 76a and an uprise part 76b.

The non-ejection-side penetrating part 76a penetrates the actuator plate 53 in the Z direction. In other words, the non-ejection-side penetrating part 76a is formed to have a uniform groove depth in the Z direction. The non-ejection-side penetrating part 76a constitutes a portion other than the +Y-side end portion in the non-ejection channel 76. The non-ejection-side penetrating part 76a is opened outside the head chip 50 through an end surface opening part formed on an end surface facing to the −Y side in the actuator plate 53.

The uprise part 76b constitutes the +Y-side end portion in the non-ejection channel 76. The uprise part 76b has a circular arc shape constant in curvature radius viewed from the X direction. The uprise part 76b decreases in depth in the Z direction as getting away from the non-ejection-side penetrating part 76a in the Y direction.

As shown in FIG. 6 and FIG. 7, the dimension in the Y direction of the non-ejection channel 76 (the non-ejection-side penetrating part 76a) is made larger than that of the ejection channel 75. Specifically, the +Y-side end portion of the non-ejection-side penetrating part 76a constitutes a first protruding part 77 located at the +Y side of the ejection channel 75 (the ejection-side penetrating part 75c). The -Y-side end portion of the non-ejection-side penetrating part 76a constitutes a second protruding part 78 located at the −Y side of the ejection channel 75 (the ejection-side penetrating part 75c).

As shown in FIG. 5, the second channel column 62 has a configuration in which the ejection channels (jet channels) 75 and the non-ejection channels (non-jet channels) 76 are arranged alternately in the X direction similarly to the first channel column 61. Specifically, the ejection channels 75 and the non-ejection channels 76 in the second channel column 62 are arranged so as to be shifted as much as a half pitch with respect to the arrangement pitch of the ejection channels 75 and the non-ejection channels 76 in the first channel column 61. Therefore, in the inkjet head 5 according to the present embodiment, the ejection channels 75 of the first channel column 61 and the second channel column 62 are arranged in a zigzag manner (a staggered manner), and the non-ejection channels 76 of the first channel column 61 and the second channel column 62 are arranged in a zigzag manner (a staggered manner). In other words, the ejection channel 75 and the non-ejection channel 76 are opposed to each other between the channel columns 61, 62 adjacent to each other in the Y direction. It should be noted that the arrangement pitch of the ejection channels 75 and the arrangement pitch of the non-ejection channels 76 can arbitrarily be changed between the channel columns 61, 62. For example, between the channel columns 61, 62, the ejection channels 75 can be arranged so as to be opposed to each other in the Y direction, and the non-ejection channels 76 can be arranged so as to be opposed to each other in the Y direction.

In the channel columns 61, 62, the ejection channels 75 are formed in a plane-symmetrical manner with respect to an X-Z plane. In the channel columns 61, 62, the non-ejection channels 76 are formed in a plane-symmetrical manner with respect to the X-Z plane. In the channel columns 61, 62, the respective uprise parts 76b at least partially overlap each other when viewed from the X direction. It should be noted that the respective uprise parts 76b of the channel columns 61, 62 are not required to overlap each other when viewed from the X direction.

In the actuator plate 53, a portion located at the −Y side (at an opposite side to the second channel column 62) of the ejection channel 75 (the ejection-side penetrating part 75c) of the first channel column 61 constitutes a first tail part 81.

In the actuator plate 53, a portion located at the +Y side (at an opposite side to the first channel column 61) of the ejection channel 75 of the second channel column 62 constitutes a second tail part 86.

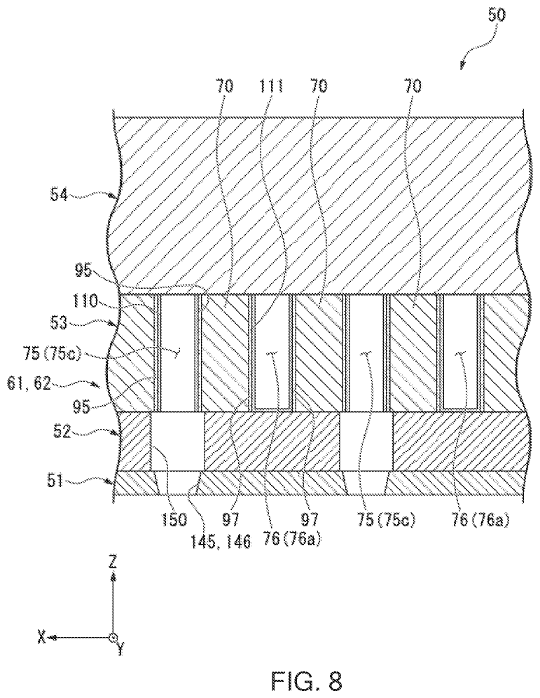

FIG. 8 is a cross-sectional view along a line VIII-VIII shown in FIG. 4.

As shown in FIG. 8, on inner side surfaces (surfaces opposed to each other in the X direction in the inner surfaces of the ejection channel 75) facing each of the ejection channels 75 in the drive walls 70 of the actuator plate 53, there are respectively formed common electrodes 95. The common electrodes 95 are made equivalent in length in the Y direction to the ejection-side penetrating part 75c (equivalent in length to an opening of the ejection channel 75 on the lower surface of the actuator plate 53). The common electrodes 95 are each formed throughout the entire area in the Z direction on the inner side surface of the ejection-side penetrating part 75c.

As shown in FIG. 5, on the lower surface of the actuator plate 53, there is formed a plurality of common terminals 96. The common terminals 96 are made to have strip-like shapes extending in the Y direction in parallel to each other. The common terminals 96 are each coupled to the pair of common electrodes 95 at an opening edge of the ejection channel 75 corresponding to the common terminal 96. The common terminals 96 are each terminated on a lower surface of corresponding one of the tail parts 81, 86.

As shown in FIG. 8, on inner side surfaces (surfaces opposed to each other in the X direction in the non-ejection channel 76) facing each of the non-ejection channels 76 in the drive walls 70 of the actuator plate 53, there are respectively formed individual electrodes 97. The individual electrodes 97 are made equivalent in length in the Y direction to the non-ejection-side penetrating part 76a. The individual electrodes 97 are each formed throughout the entire area in the Z direction on the inner side surface of the non-ejection-side penetrating part 76a.

As shown in FIG. 5, in portions located at an outer side of the common terminals 96 on the lower surfaces of the tail parts 81, 86, there are formed individual terminals 98. The individual terminal 98 is made to have a strip-like shape extending in the X direction. The individual terminal 98 couples the individual electrodes 97 opposed to each other in the X direction across the ejection channel 75 at the opening edges of the non-ejection channels 76 which are opposed to each other in the X direction across the ejection channel 75. It should be noted that in a portion located between the common terminal 96 and the individual terminal 98 in each of the tail parts 81, 86, there is formed a compartment groove 99. The compartment grooves 99 extend in the X direction in the tail parts 81, 86. The compartment groove 99 separates the common terminal 96 and the individual terminal 98 from each other.

As shown in FIG. 8, on the inner surface of the ejection channel 75, there is formed a first protective film 110. The first protective film 110 is formed throughout the entire inner surface of the ejection channel 75. The first protective film 110 covers the common electrode 95. The first protective film 110 prevents, for example, the common electrode 95 and the ink from making contact with each other. It should be noted that it is sufficient for the first protective film 110 to cover at least the common electrode 95 on the inner side surface of the ejection channel 75.

On an inner surface of the non-ejection channel 76, there is formed a second protective film 111. The second protective film 111 is formed throughout the entire inner surface of the non-ejection channel 76. The second protective film 111 covers the individual electrode 97. The second protective film 111 prevents, for example, the individual electrode 97 and the ink from making contact with each other. It should be noted that it is sufficient for the second protective film 111 to cover at least the individual electrode 97 on the inner side surface of the non-ejection channel 76.

The protective films 110, 111 each include an organic insulating material such as a para-xylylene resin material (e.g., parylene (a registered trademark)) as a material having an insulating property. The protective films 110, 111 can be formed of tantalum oxide (Ta₂O₅), silicon nitride (SiN), silicon carbide (SiC), silicon oxide (SiO₂), diamond-like carbon, or the like, or can include at least any one of these materials.

As shown in FIG. 6, a first flexible printed board 100 is pressure-bonded to the lower surface of the first tail part 81. The first flexible printed board 100 is coupled to the common terminals 96 and the individual terminals 98 corresponding to the first channel column 61 on the lower surface of the first tail part 81. The first flexible printed board 100 is extracted upward passing through the outside of the actuator plate 53.

A second flexible printed board 101 is pressure-bonded to the lower surface of the second tail part 86. The second flexible printed board 101 is coupled to the common terminals 96 and the individual terminals 98 corresponding to the second channel column 62 on the lower surface of the second tail part 86. The second flexible printed board 101 is extracted upward through the outside of the actuator plate 53.

### <Cover Plate 54>

As shown in FIG. 3 and FIG. 4, the cover plate 54 is bonded to an upper surface of the actuator plate 53 so as to close the channel columns 61, 62. In the cover plate 54, at positions corresponding to the channel columns 61, 62, there are formed entrance common ink chambers 120 and exit common ink chambers 121, respectively.

The entrance common ink chamber 120 is formed at a position overlapping, for example, the +Y-side end portion of the first channel column 61 in the plan view. The entrance common ink chamber 120 extends in the X direction with a length sufficient for straddling, for example, the first channel column 61, and at the same time, opens on an upper surface of the cover plate 54.

The exit common ink chamber 121 is formed at a position overlapping, for example, the −Y-side end portion of the first channel column 61 in the plan view. The exit common ink chamber 121 extends in the X direction with a length sufficient for straddling the first channel column 61, and at the same time, opens on the upper surface of the cover plate 54.

In the entrance common ink chamber 120, at positions overlapping the ejection channels 75 (the first uprise parts 75a) in the first channel column 61 in the plan view, there are formed entrance slits (liquid flow channels) 125. The entrance slits 125 each make the ejection channel 75 and the entrance common ink chamber 120 communicate with each other.

In the exit common ink chamber 121, at positions overlapping the ejection channels 75 (the second uprise parts 75b) in the first channel column 61 in the plan view, there are formed exit slits (liquid flow channels) 126. The exit slits 126 each make the ejection channel 75 and the exit common ink chamber 121 communicate with each other. Therefore, the entrance slits 125 and the exit slits 126 are communicated with the respective ejection channels 75 on the one hand, but are not communicated with the non-ejection channels 76 on the other hand.

### <Intermediate Plate 52>

The intermediate plate 52 is bonded to the lower surface of the actuator plate 53 so as to close the channel columns 61, 62. The intermediate plate 52 is formed of a piezoelectric material such as PZT similarly to the actuator plate 53. The intermediate plate 52 is thinner in thickness in the Z direction than the actuator plate 53. The intermediate plate 52 is made smaller in dimension in the Y direction than the actuator plate 53. Therefore, at the both sides in the Y direction of the intermediate plate 52, there are exposed the both end portions (the tail parts 81, 86) in the Y direction in the actuator plate 53. In the both end portions in the Y direction in the actuator plate 53, the portions exposed from the intermediate plate 52 function as pressure-bonding areas for the first flexible printed board 100 and the second flexible printed board 101, respectively. It should be noted that the intermediate plate 52 can be formed of a material (e.g., a nonconductive material such as polyimide or alumina) other than the piezoelectric material.

### <Nozzle Plate 51>

As shown in FIG. 4, the nozzle plate 51 is fixed by bonding or the like to a lower surface of the intermediate plate 52. The nozzle plate 51 is made equivalent in width in the Y direction to the intermediate plate 52. In the present embodiment, the nozzle plate 51 is formed of a resin material such as polyimide so as to have a thickness of about 50 μm. It should be noted that it is possible for the nozzle plate 51 to have a single layer structure or a laminate structure with a metal material (SUS, Ni—Pd, or the like), glass, silicone, or the like besides the resin material.

The nozzle plate 51 is provided with two nozzle arrays (a first nozzle array 141 and a second nozzle array 142) extending in the X direction formed at a distance in the Y direction.

The nozzle arrays 141, 142 each include a plurality of nozzle holes (first nozzle holes 145 and second nozzle holes 146) each penetrating the nozzle plate 51 in the Z direction. The nozzle holes 145 and the nozzle holes 146 are each arranged at intervals in the X direction. Each of the nozzle holes 145, 146 is formed to have, for example, a taper shape having an inner diameter gradually decreasing in a direction from the lower side toward the upper side. In the illustrated example, the maximum inner diameter (the inner diameter of an upper-side opening part) of each of the nozzle holes 145, 146 is set no smaller than the dimension in the X direction in the ejection channel 75.

Then, the details of the intermediate plate 52 will be described. Hereinafter, ejecting communication holes 150, ejection-side introduction ports 151, 152, and non-ejection-side introduction ports 155 provided to the intermediate plate 52 will be described taking the first channel column 61 as an example.

As shown in FIG. 4 through FIG. 8, in the intermediate plate 52, at positions overlapping the first nozzle holes 145 in the plan view, there are formed the ejecting communication holes 150. The ejecting communication holes 150 each penetrate the intermediate plate 52 in the Z direction. The ejecting communication holes 150 each make the ejection channel 75 and the first nozzle hole 145 corresponding to each other communicate with each other out of the plurality of ejection channels 75 and the plurality of first nozzle holes 145. In other words, the ejecting communication holes 150 are each communicated with the ejection channel 75 through a lower-side opening part of the ejection channel 75 (the ejection-side penetrating part 75c). Meanwhile, the ejecting communication holes 150 are each communicated with the first nozzle hole 145 through the upper-side opening part of the first nozzle hole 145. Therefore, the non-ejection channels 76 are not communicated with the first nozzle holes 145, but are covered with the intermediate plate 52 from below.

The ejecting communication holes 150 are each formed to have a uniform dimension in the Y direction and a uniform dimension in the X direction throughout the entire length in the Z direction. It should be noted that it is possible for the ejecting communication holes 150 to be formed to have a taper shape or a step shape increasing in dimension in the X direction in, for example, a downward direction.

The dimension in the Y direction in the ejecting communication holes 150 is set smaller than a dimension in the Y direction in the ejection-side penetrating part 75c, and larger than a dimension in the Y direction in the nozzle holes 145, 146. It should be noted that the dimension in the Y direction in the ejecting communication holes 150 can be larger than the dimension in the Y direction in the ejection-side penetrating part 75c.

It is preferable for the dimension in the X direction in the ejecting communication holes 150 to be larger than that of a maximum inner diameter part (the upper-side opening part) of the nozzle holes 145, 146. It should be noted that the dimension in the X direction in the ejecting communication holes 150 can be set no larger than the dimension in the X direction in the ejection channel 75.

In the intermediate plate 52, at positions which overlap the ejection-side penetrating parts 75c in the plan view, and which do not overlap the first nozzle holes 145, there are formed ejection-side introduction ports (the first ejection-side introduction ports 151 and the second ejection-side introduction ports 152). The first ejection-side introduction ports 151 are located at the +Y side with respect to the ejecting communication holes 150, and the second ejection-side introduction ports 152 are located at the −Y side with respect to the ejecting communication holes 150.

The first ejection-side introduction ports 151 each have a function as an introduction port for introducing the formation material of the first protective film 110 into the ejection channel 75, and a function as a containing part of an adhesive when bonding the nozzle plate 51 to the intermediate plate 52. The first ejection-side introduction ports 151 are each a circular hole which has a circular planar shape, and which penetrates the intermediate plate 52 in the Z direction. An upper-side opening part of the first ejection-side introduction port 151 is communicated with the inside of the ejection channel 75 through the ejection-side penetrating part 75c. A lower-side opening part of the first ejection-side introduction port 151 is closed by the nozzle plate 51 from below. The inner diameter of the first ejection-side introduction port 151 is twice or more as large as the film thickness of the first protective film 110 provided to the ejection channel 75, and is made smaller than the dimension in the X direction in the ejection-side penetrating part 75c. It should be noted that the inner diameter of the first ejection-side introduction port 151 can arbitrarily be changed.

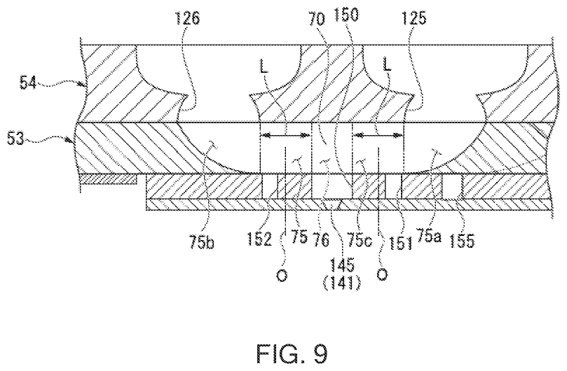

FIG. 9 is an enlarged view of FIG. 6.

As shown in FIG. 9, the first ejection-side introduction port 151 is disposed in a portion located so as to be shifted toward the first uprise part 75a (the entrance slit 125) with respect to the center O in the Y direction in an area L between the entrance slit 125 and the ejecting communication hole 150. It should be noted that the position in the Y direction in the first ejection-side introduction port 151 can arbitrarily be changed in accordance with a film thickness distribution of the first protective film 110 in the ejection channel 75 when the first ejection-side introduction port 151 is not disposed. For example, the first ejection-side introduction port 151 can be disposed in a portion including the center O in the Y direction in the area L between the entrance slit 125 and the ejecting communication hole 150.

The second ejection-side introduction port 152 is formed with an equivalent outer shape to that of the first ejection-side introduction port 151 at a position to be symmetric with the first ejection-side introduction port 151 in the Y direction across the first nozzle hole 145. It should be noted that the position and the shape of the second ejection-side introduction port 152 can arbitrarily be changed regardless of the position and the shape of the first ejection-side introduction port 151. For example, when a pressure loss is different between the first uprise part 75a and the second uprise part 75b in the ejection channel 75, one of the ejection-side introduction ports 151, 152 disposed in the uprise part higher in pressure loss can be disposed at a position farther in the Y direction from the first nozzle hole 145. Further, it is sufficient for each of the ejection-side introduction ports 151, 152 to be provided as much as at least one.

As shown in FIG. 7, the non-ejection-side introduction port 155 penetrates the intermediate plate 52 in the Z direction at a position which overlaps the non-ejection-side penetrating part 76a and does not overlap the ejection-side penetrating part 75c in the intermediate plate 52 in the plan view. Specifically, the non-ejection-side introduction port 155 is disposed at a position overlapping the first protruding part 77 in the plan view in a portion located at the +Y side with respect to the first ejection-side introduction port 151 in the intermediate plate 52. Therefore, the non-ejection-side introduction port 155 is communicated with the inside of the non-ejection channel 76 (the first protruding part 77) through the upper-side opening part. The lower-side opening part of the non-ejection-side introduction port 155 is closed by the nozzle plate 51. It should be noted that the non-ejection-side introduction port 155 is not required to be closed by the nozzle plate 51.

It should be noted that the position in the Y direction in the non-ejection-side introduction port 155 can arbitrarily be changed in accordance with a film thickness distribution of the second protective film 111 in the non-ejection channel 76 when the non-ejection-side introduction port 155 is not disposed. For example, the non-ejection channel 76 is opened on the −Y-side end surface of the actuator plate 53 in the −Y-side end portion of the non-ejection-side penetrating part 76a on the one hand, but is communicated with the uprise part 76b in the +Y-side end portion of the non-ejection-side penetrating part 76a on the other hand. Therefore, the +Y-side end portion in the non-ejection channel 76 is smaller in flow channel cross-sectional area than the −Y-side end portion, and is a place where the pressure loss becomes relatively high. Therefore, it is difficult for the formation material of the second protective film 111 to pervade the +Y-side end portion in the non-ejection channel 76. Therefore, the non-ejection-side introduction port 155 is disposed in a portion located at the +Y side with respect to the first ejection-side introduction port 151 in the intermediate plate 52.

The non-ejection-side introduction port 155 linearly extends in the X direction with a length sufficient for straddling the first channel column 61. Therefore, the non-ejection-side introduction port 155 is communicated with each of the non-ejection channels 76 in the first channel column 61. It should be noted that the non-ejection-side introduction port 155 can be disposed for each of the non-ejection channels 76. In this case, the position and the size of the non-ejection-side introduction port 155 can arbitrarily be changed irrespective of the position of the ejection channel 75 (the ejection-side penetrating part 75c).

### [Operation Method of Printer 1]

Then, there will hereinafter be described a case when recording a character, a figure, or the like on the recording target medium P using the printer 1 configured as described above.

It should be noted that it is assumed that as an initial state, the sufficient ink having colors different from each other is respectively encapsulated in the four ink tanks 4 shown in FIG. 1. Further, there is provided the state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12 of the conveying mechanisms 2, 3. Further, by the carriage 29 moving in the Y direction at the same time, the inkjet heads 5 mounted on the carriage 29 reciprocate in the Y direction.

While the inkjet heads 5 reciprocate, the ink is arbitrarily ejected toward the recording target medium P from each of the inkjet heads 5. Thus, it is possible to perform recording of the character, the image, and the like on the recording target medium P.

Here, the operation of each of the inkjet heads 5 will hereinafter be described in detail.

In such circulating side-shooting type inkjet head 5 as in the present embodiment, first, by making the pressure pump 24 and the suction pump 25 shown in FIG. 2 operate, the ink is circulated in the circulation flow channel 23. In this case, the ink circulating through the ink supply tube 21 is supplied to the inside of each of the ejection channels 75 through the entrance common ink chambers 120 and the entrance slits 125. The ink supplied to the inside of each of the ejection channels 75 circulates the ejection channels 75 in the Y direction. Subsequently, the ink is discharged to the exit common ink chambers 121 through the exit slits 126, and is then returned to the ink tank 4 through the ink discharge tube 22. Thus, it is possible to circulate the ink between the inkjet head 5 and the ink tank 4.

Then, when the reciprocation of the inkjet head 5 is started due to the translation of the carriage 29 (see FIG. 1), the drive voltages are applied to the electrodes 95, 97 via the flexible printed boards 100, 101. On this occasion, the individual electrode 97 is set at a drive potential Vdd, and the common electrode 95 is set at a reference potential GND to apply the drive voltage between the electrodes 95, 97. Then, a thickness shear deformation occurs in the two drive walls 70 partitioning the ejection channel 75, and the two drive walls 70 each deform so as to protrude toward the non-ejection channel 76. Specifically, by applying the voltage between the electrodes 95, 97, the drive walls 70 each make a flexural deformation to form a V-shape centering on an intermediate portion in the Z direction. Thus, the volume of the ejection channel 75 increases. Further, since the volume of the ejection channel 75 has increased, the ink retained in the entrance common ink chamber 120 is induced into the ejection channel 75 through the entrance slit 125. The ink having been induced into the ejection channel 75 propagates inside the ejection channel 75 forming a pressure wave. The voltage applied between the electrodes 95, 97 is set to zero at the timing when the pressure wave reaches corresponding one of the nozzle holes 145, 146. Thus, the drive walls 70 are restored, and the volume of the ejection channel 75 having once increased is restored to the original volume. Due to this operation, the internal pressure of the ejection channel 75 increases to pressurize the ink. As a result, it is possible to record the character, the image, and the like on the recording target medium P as described above by the ink shaped like a droplet being ejected outside through the ejecting communication hole 150 and corresponding one of the nozzle holes 145, 146.

### <Method of Manufacturing Head Chip 50>

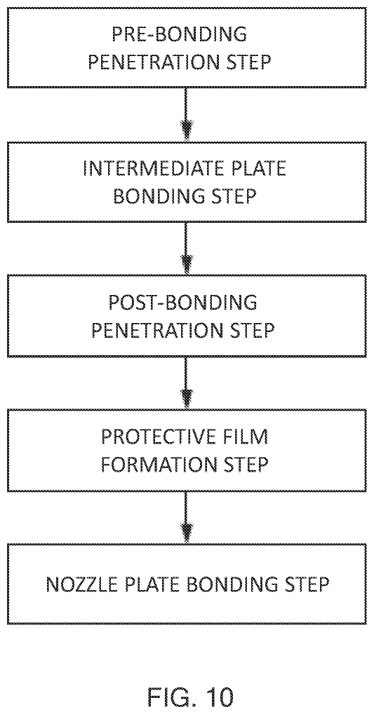

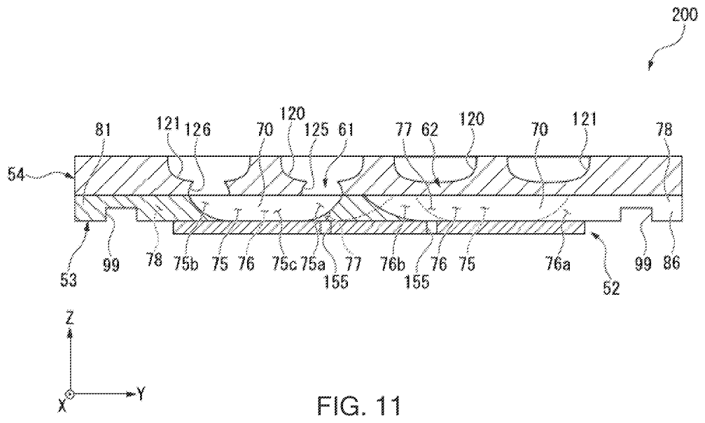

Then, a method of manufacturing such a head chip 50 as described above will be described. FIG. 10 is a flowchart for explaining the method of manufacturing the head chip 50. FIG. 11 through FIG. 13 are each a diagram for explaining a step of the method of manufacturing the head chip 50, and are each a cross-sectional view corresponding to FIG. 6. In the following description, there is described a case when manufacturing the head chip 50 chip by chip as an example for the sake of convenience.

As shown in FIG. 10, the method of manufacturing the head chip 50 is provided with a pre-bonding penetration step (a second communication step, a third communication step), an intermediate plate bonding step (an intermediate plate stacking step), a post-bonding penetration step (a first communication step), a protective film formation step, and a nozzle plate bonding step. It should be noted that it is assumed that the processing necessary in advance of the intermediate plate bonding step has already been performed on each of the plates 51 through 54.

In the pre-bonding penetration step, the non-ejection-side introduction ports 155 are provided to the intermediate plate 52. Specifically, the non-ejection-side introduction ports 155 are made to penetrate the intermediate plate 52 by performing laser processing on the formation areas of the non-ejection-side introduction ports 155 in the intermediate plate 52. It should be noted that the non-ejection-side introduction ports 155 can be processed by etching or the like. In the pre-bonding penetration step, a step of forming the non-ejection-side introduction ports 155 corresponds to, for example, the third communication step according to the present disclosure.

As shown in FIG. 11, in the intermediate plate bonding step, the intermediate plate 52 provided in advance with the non-ejection-side introduction ports 155 is bonded to a stacked body 200 having the actuator plate 53 and the cover plate 54 stacked on one another. Specifically, the intermediate plate 52 is bonded to a lower surface of the actuator plate 53 via an adhesive or the like so that the non-ejection-side introduction port 155 and the non-ejection channels 76 (the non-ejection-side penetrating parts 76a) overlap each other. It should be noted that in the intermediate plate bonding step, the ejecting communication holes 150 and the ejection-side introduction ports 151, 152 are not yet formed.

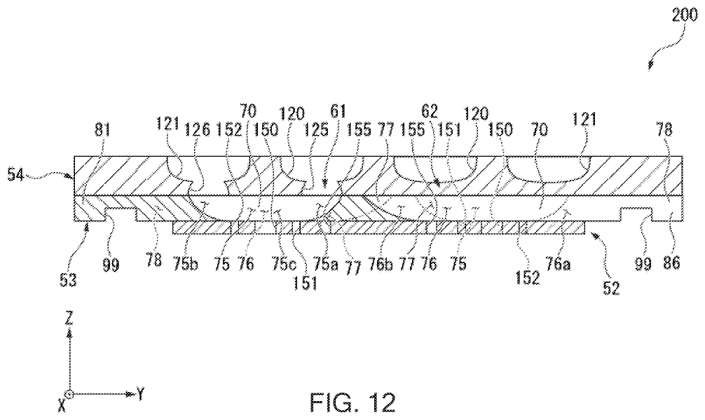

As shown in FIG. 12, in the post-bonding penetration step, the ejecting communication holes 150 and the ejection-side introduction ports 151, 152 are provided to the intermediate plate 52. Specifically, in the post-bonding penetration step, laser processing is performed on portions overlapping the ejection channels 75 (the ejection-side penetrating parts 75c) in the plan view in the lower surface of the intermediate plate 52 to thereby penetrate the intermediate plate 52. As in the present embodiment, by forming the ejecting communication holes 150 and the ejection-side introduction ports 151 in the state in which the intermediate plate 52 is stacked on the actuator plate 53, it is possible to improve the positional accuracy between the ejection channels 75 and the ejecting communication holes 150.

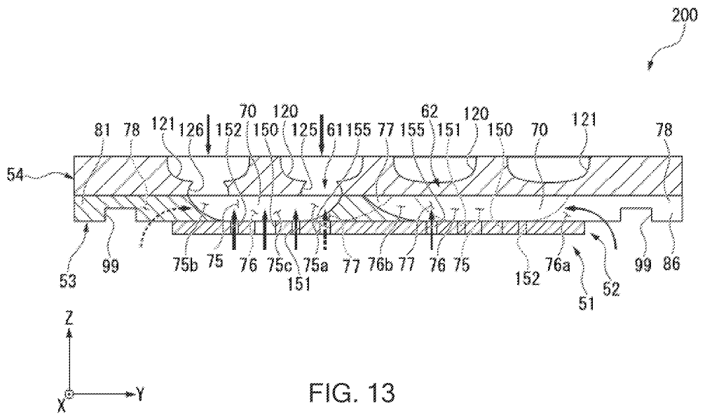

As shown in FIG. 13, in the protective film formation step, the first protective film 110 is formed in each of the ejection channels 75, and at the same time, the second protective film 111 is formed on the inner surface of each of the non-ejection channels 76. The protective films 110, 111 are formed by film-forming a para-xylylene resin material using, for example, a chemical vapor deposition method (CVD). Specifically, in the state in which the stacked body is set in a chamber (not shown), a raw material gas to be the formation material of the protective films 110, 111 is introduced. On this occasion, the raw material gas is introduced into the ejection channels 75 through the slits 125, 126, the ejecting communication holes 150, and the ejection-side introduction ports 151 (see arrows in FIG. 13). By the raw material gas introduced into the ejection channels 75 adhering to the inner surfaces of the ejection channels 75, the raw material is deposited on the inner surfaces of the ejection channels 75 as the first protective films 110.

Into the non-ejection channels 76, there is introduced the raw material gas through the non-ejection-side penetrating parts 76a and the non-ejection-side introduction ports 155 (see arrows in FIG. 13). By the raw material gas introduced into the non-ejection channels 76 adhering to the inner surfaces of the non-ejection channels 76, the raw material is deposited as the second protective films 111. It should be noted that a part of the formation material of the protective films which fails to completely pass through the ejection-side introduction ports 151, 152 and the non-ejection-side introduction ports 155 can be deposited on the inner surfaces of the ejection-side introduction ports 151, 152 and the non-ejection-side introduction ports 155.

In the nozzle plate bonding step, the nozzle plate 51 and the intermediate plate 52 are bonded to each other so that the nozzle holes 145, 146 are communicated with the inside of the ejection channels 75 through the ejecting communication holes 150, and at the same time, the ejection-side introduction ports 151 and the non-ejection-side introduction ports 155 are closed. It should be noted that when bonding the nozzle plate 51 with the adhesive, a superfluous adhesive drifted by the nozzle plate 51 and the intermediate plate 52 is housed in the ejection-side introduction ports 151, 152 and the non-ejection-side introduction ports 155.

Due to the steps described hereinabove, the head chip 50 is manufactured.

It should be noted that the head chips 50 can be manufactured in terms of wafer. When manufacturing the head chips 50 in terms of wafer, an actuator wafer having a plurality of actuator plates 53 connected to each other, a cover wafer having a plurality of cover plates 54 connected to each other, and an intermediate wafer having a plurality of intermediate plates 52 connected to each other are bonded to one another to form a wafer assembly. Subsequently, the protective films 110, 111 are provided to the wafer assembly, and then, the wafer assembly is cut to thereby form a plurality of head chips 50.

As described above, in the present embodiment, there is adopted a configuration provided with the intermediate plate 52 in which the ejecting communication holes 150 respectively communicated with the inside of the plurality of ejection channels 75 and the ejection-side introduction ports 151, 152 are formed, and the nozzle plate 51 bonded to the intermediate plate 52 in the state in which the ejecting communication holes 150 are respectively communicated with the nozzle holes 145, 146, and at the same time, the ejection-side introduction ports 151, 152 are closed.

According to this configuration, when forming the first protective films 110 in the ejection channels 75 in the state in which the intermediate plate 52 is disposed, it is possible to introduce the formation material of the first protective films 110 through the ejection-side introduction ports 151, 152 in addition to the ejecting communication holes 150. Thus, it is easy to homogenously form the first protective films 110 in the ejection channels 75. In this case, it is possible to prevent the damage from being inflicted on the first protective films 110 and so on when forming the ejecting communication holes 150 compared to when bonding the intermediate plate 52 to the actuator plate 53 provided with the first protective films 110, and then forming the ejecting communication holes 150 as post-processing.

As a result, it is possible to homogenously form the first protective films 110 on the inner surfaces of the ejection channels 75 to protect the common electrodes 95 while dealing with the miniaturization of the ejection channels 75 and the reduction in pitch of the ejection channels 75.

Incidentally, when forming the first protective films 110 in the state in which the cover plate 54 and the intermediate plate 52 are stacked on one another, the formation material of the first protective films 110 is introduced in the ejection channels 75 through the ejecting communication holes 150 and the slits 125, 126 when the ejection-side introduction ports 151, 152 are not formed. On this occasion, in the ejection channels 75, it is difficult for the first protective films 110 to reach an intermediate portion between the ejecting communication holes 150 and the slits 126. Therefore, in the ejection channels 75, it is difficult for the intermediate portion between the ejecting communication holes 150 and the slits 125, 126 to ensure the film thickness of the first protective films 110 as a film thickness minimum portion.

Therefore, in the present embodiment, there is adopted a configuration in which the first ejection-side introduction ports 151 (the second ejection-side introduction ports 152) are communicated with the ejection channels 75 in the portions located between the entrance slits 125 (the exit slits 126) and the ejecting communication holes 150 in the Y direction.

According to this configuration, by disposing the ejection-side introduction ports 151, 152 in the portions located between the slits 125, 126 and the ejecting communication holes 150 in the Y direction, it is possible to increase the film thickness in the film thickness minimum portions. Therefore, it is possible to homogenously form the first protective films 110 on the inner surfaces of the ejection channels 75.

In the present embodiment, there is adopted the configuration in which the first ejection-side introduction ports 151 are disposed in the portions each located so as to be shifted toward the first uprise part 75a with respect to the center in the Y direction between the entrance slits 125 and the ejecting communication holes 150.

For example, in the ejection channels 75, the portions each located so as to be shifted toward the first uprise part 75a (the entrance slit 125) are the places where the flow channel cross-sectional area is small and the pressure loss becomes relatively high. Therefore, when introducing the formation material of the first protective films 110 through the ejecting communication holes 150, the formation material of the first protective films 110 is difficult to pervade the portions. In view of the above, by disposing the ejection-side introduction port 151, 152 in the portion located so as to be shifted toward the uprise part 75a, 75b (the entrance slit 125 or the exit slit 126) with respect to the center O in the Y direction in the area L between the entrance slit 125 and the ejecting communication hole 150, it is possible to more surely form the first protective film to the film thickness minimum portion.

In the present embodiment, there is adopted the configuration in which the inner diameters of the ejection-side introduction ports 151, 152 are set no larger than the dimension in the X direction in the ejection-side penetrating part 75c.

According to this configuration, even when forming the ejection-side introduction ports 151, 152 as post-processing after bonding the intermediate plate 52 and the actuator plate 53 to each other, it is possible to prevent the damage from being inflicted on the actuator plate 53 when processing the ejection-side introduction ports 151, 152.

In the present embodiment, there is adopted a configuration in which the ejection-side introduction ports 151, 152 are formed to have a circular shape when viewed from an opening direction (the Z direction).

According to this configuration, since a corner part is not formed on the inner surfaces of the ejection-side introduction ports 151, 152, it is possible to prevent the retention of bubbles in the ejection-side introduction ports 151, 152. By preventing the retention of the bubbles, it is possible to prevent the bubbles from being discharged from the nozzle holes 145, 146 when ejecting the ink. As a result, it is possible to prevent a printing failure such as white slip to thereby perform high-precision printing.

In the present embodiment, it is assumed to adopt the configuration in which the inner diameter (the dimension between the portions opposed to each other in the X direction) of the ejection-side introduction ports 151, 152 is twice or more as large as the film thickness of the first protective film 110.

According to this configuration, it is possible to prevent the ejection-side introduction ports 151, 152 from being closed by the first protective films 110 to be attached to the inner surfaces of the ejection-side introduction ports 151, 152 before the completion of the introduction of the first protection films 110 into the ejection channels 75 when forming the first protective films 110. As a result, it is possible to surely introduce the formation material of the first protective film 110 into the ejection channels 75.

In the present embodiment, there is adopted the configuration in which a part of the adhesive is housed in the ejection-side introduction ports 151, 152.

According to this configuration, it is possible to prevent the superfluous adhesive from reaching the ejecting communication holes 150 and the nozzle holes 145, 146 when bonding the nozzle plate 51 and the intermediate plate 52 to each other. As a result, it is possible to prevent the ink flow from being hindered by the adhesive to thereby prevent the ejection performance from deteriorating.

Further, since it is possible to reduce an effective volume of the ejection-side introduction ports 151, 152 after forming the protective films, it is possible to prevent the bubbles from being retained in the ejection-side introduction ports 151, 152 when using the head chip 50. By preventing the retention of the bubbles, it is possible to prevent the bubbles from being discharged from the nozzle holes 145, 146 when ejecting the ink. As a result, it is possible to prevent a printing failure such as white slip to thereby perform high-precision printing.

In the present embodiment, there is adopted the configuration in which the intermediate plate 52 is provided with the non-ejection-side introduction ports 155 communicated with the non-ejection channels 76.

According to this configuration, it is possible to introduce the formation material of the second protective films 111 into the non-ejection channels 76 through the non-ejection-side introduction ports 155. Therefore, it is easy to homogenously form the second protective films 111 in the non-ejection channels 76.

Incidentally, when forming the second protective films 111 in the state in which the cover plate 54 and the intermediate plate 52 are stacked on one another, the formation material of the second protective films 111 is introduced into the non-ejection channels 76 through the end surface opening part facing to the Y direction in the actuator plate 53 when the non-ejection-side introduction ports 155 are not formed. On this occasion, in the non-ejection channels 76, it is difficult for the second protective films 111 to reach an end portion at an opposite side to the end surface opening part. Therefore, in the non-ejection channels 76, it is difficult for the end portion at the opposite side to the end surface opening part side to ensure the film thickness of the second protective films 111 as a film thickness minimum portion.

Therefore, in the present embodiment, by disposing the non-ejection-side introduction ports 155 in the end portions at the opposite side to the end surface opening part side in the non-ejection channels 76, it is possible to form the second protective films 111 in the film thickness minimum portion.

In the present embodiment, there is adopted the configuration in which the non-ejection-side introduction ports 155 extend in the X direction traversing an area between the first protruding parts 77 of the non-ejection channels 76 adjacent to each other in the X direction, and are each communicated collectively with the non-ejection channels 76 adjacent to each other through the first protruding part 77.

According to this configuration, it is possible to share the non-ejection-side introduction ports 155 between the non-ejection channels 76 adjacent to each other. Therefore, it is possible to increase the manufacturing efficiency compared to the configuration in which the non-ejection-side introduction ports 155 are provided for each of the non-ejection channels 76 adjacent to each other.

Since the inkjet head 5 and the printer 1 according to the present embodiment are each provided with the head chip 50 described above, it is possible to provide the liquid jet head high in quality and excellent in reliability.

In the present embodiment, there is adopted the configuration in which the ejecting communication holes 150 and the ejection-side introduction ports 151, 152 are formed as the post-bonding penetration step between the intermediate plate bonding step and the protective film formation step.

According to this configuration, by forming the ejecting communication holes 150 and the ejection-side introduction ports 151, 152 in the state in which the intermediate plate 52 is stacked on the actuator plate 53, it is possible to improve the positional accuracy between the ejection channels 75 and the ejecting communication holes 150 and the ejection-side introduction ports 151, 152.

It should be noted that although in the first embodiment described above, there is described the method of forming the ejecting communication holes 150 and the ejection-side introduction ports 151, 152 as the post-bonding penetration step after the intermediate plate bonding step, this configuration is not a limitation. It is possible to adopt a configuration in which the ejection-side introduction ports 151, 152 are formed in advance in the pre-bonding penetration step, and at least the ejecting communication holes 150 are formed in the post-bonding penetration step. According to this configuration, by forming the ejection-side introduction ports 151, 152 in advance, it is possible to shorten the processing time after stacking the intermediate plate 52 until the head chip 50 is completed. In the pre-bonding penetration step, a step of forming the ejection-side introduction ports 151, 152 corresponds to, for example, the second communication step according to the present disclosure.

In the first embodiment described above, there is described the configuration in which the non-ejection-side introduction ports 155 are formed in the pre-bonding penetration step, but this configuration is not a limitation. For example, when forming the non-ejection-side introduction port 155 for each of the non-ejection channels 76, it is possible to form the non-ejection-side introduction ports 155 in the post-bonding penetration step.

In the present embodiment, there is adopted the configuration in which the non-ejection-side introduction ports 155 are formed as the pre-bonding penetration step, and the intermediate plate stacking step of stacking the intermediate plate 52 provided with the non-ejection-side introduction ports 155 on the actuator plate 53 is provided in an anterior stage of the protective film formation step.

According to this configuration, by forming the non-ejection-side introduction ports 155 in advance, it is possible to shorten the processing time after stacking the intermediate plate 52 until the head chip 50 is completed.

### Second Embodiment

In the embodiment described above, there is described the configuration in which the non-ejection-side introduction ports 155 are disposed for the respective cannel columns 61, 62, but this configuration is not a limitation.

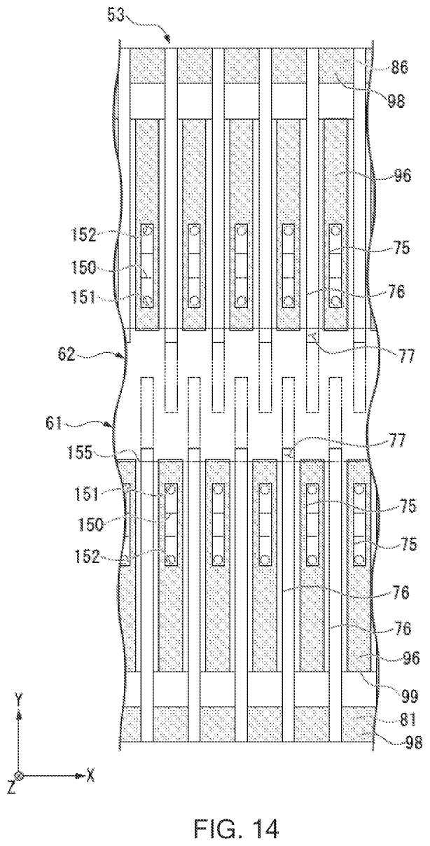

Specifically, as in the head chip 50 shown in FIG. 14, the non-ejection-side introduction ports 155 can be disposed so as to straddle the first channel column 61 and the second channel column 62. Specifically, as the non-ejection-side introduction port 155, an area including a portion overlapping the first protruding part 77 of the first channel column 61 in the plan view and a portion overlapping the first protruding part 77 in the second channel column 62 in the plan view out of the intermediate plate 52 penetrates in the Z direction.

According to this configuration, since it is possible to ensure the non-ejection-side introduction port 155 large in size compared to when forming the non-ejection-side introduction port 155 for each of the channel columns 61, 62, it becomes easy to perform alignment of the non-ejection channel 76 and the non-ejection-side introduction port 155 in the intermediate plate bonding step.

### Other Modified Examples

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording device, but the liquid jet recording device is not limited to the printer. For example, a facsimile machine, an on-demand printing machine, and so on can also be adopted.

In the embodiments described above, the description is presented citing the configuration (a so-called shuttle machine) in which the inkjet head moves with respect to the recording target medium when performing printing as an example, but this configuration is not a limitation. The configuration related to the present disclosure can be adopted as the configuration (a so-called stationary head machine) in which the recording target medium is moved with respect to the inkjet head in the state in which the inkjet head is fixed.

In the embodiments described above, there is described a case when the recording target medium P is paper, but this configuration is not a limitation. The recording target medium P is not limited to paper, but can also be a metal material or a resin material, and can also be food or the like.

In the embodiments described above, there is described the configuration in which the liquid jet head is installed in the liquid jet recording device, but this configuration is not a limitation. Specifically, the liquid to be jetted from the liquid jet head is not limited to what is landed on the recording target medium, but can also be, for example, a medical solution to be blended during a dispensing process, a food additive such as seasoning or a spice to be added to food, or fragrance to be sprayed in the air.

In the embodiments described above, there is described the configuration in which the Z direction coincides with the gravitational direction, but this configuration is not a limitation, and it is also possible to set the Z direction along the horizontal direction.

In the embodiments described above, there is described the configuration in which the ejection channels 75 and the non-ejection channels 76 are arranged in a staggered manner, but this configuration is not a limitation. For example, it is possible to apply the present disclosure to the head chip 50 of a so-called three-cycle type in which the ink is jetted in sequence from all of the channels.

In the embodiments described above, the description is presented citing the head chip 50 of the circulating side-shooting type as an example, but this configuration is not a limitation. The head chip can be of a so-called edge-shooting type for ejecting the ink from an end portion in the extending direction (the Y direction) in the ejection channel.

In the embodiments described above, there is described the configuration in which the actuator plate 53, the intermediate plate 52, and the nozzle plate 51 are sequentially bonded to one another, but this configuration is not a limitation. It is possible to dispose another member between the actuator plate 53 and the intermediate plate 52, or between the intermediate plate 52 and the nozzle plate 51. In this case, regarding the intermediate plate stacking step related to the present disclosure, it is not limited to a case there a stacking object is directly bonded to a stacking target object (e.g., the case there the stacking object is the intermediate plate, the stacking target object is the actuator plate), and as long as the configuration in which the stacking object is stacked on at least the stacking target object, it is possible to bond the stacking object on another member in a state in which the another member is bonded on the stacking target object. Further, even when the stacking object is directly stacked on the stacking target object, the stacking object and the stacking target object can be stacked with a method other than bonding.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
an actuator plate in which a plurality of jet channels extending in a first direction is arranged in a second direction crossing the first direction;
a first electrode formed on an inner surface of the jet channel;
a first protective film disposed so as to cover the first electrode on the inner surface of the jet channel;
an intermediate plate which has first communication holes and second communication holes respectively communicated with the plurality of jet channels, and which is disposed so as to face a channel opening surface on which the jet channels open in the actuator plate; and
a jet hole plate which has a plurality of jet holes configured to jet liquid, and which is disposed at an opposite side to the actuator plate with respect to the intermediate plate in a state in which the first communication holes are respectively communicated with the jet holes, and the second communication holes are closed.

2. The head chip according to claim 1, wherein
the channel opening surface faces to a first side in a third direction crossing the second direction when viewed from the first direction in the actuator plate,
a cover plate having a liquid flow channel communicated with the jet channels is disposed on a surface facing to a second side as an opposite side to the first side in the third direction in the actuator plate, and
the second communication holes are each communicated with the jet channel in a portion located between the liquid flow channel and the first communication hole in the first direction.

3. The head chip according to claim 2, wherein
the jet channels each include:
a penetrating part opening on the channel opening surface in a central portion in the first direction; and
an uprise part which is communicated with at least a first side end portion in the first direction with respect to the penetrating part, and which decreases in depth in the third direction as getting away from the central portion,
the liquid flow channel is communicated with the jet channel at a position overlapping the uprise part when viewed from the third direction, and
the second communication holes are each located at a side of the liquid flow channel with respect to a center in the first direction in an area between the liquid flow channel and the first communication hole.

4. The head chip according to claim 1, wherein
a dimension in the second direction in the second communication hole is set no larger than a dimension in the second direction in the jet channel.

5. The head chip according to claim 1, wherein
the second communication holes are each formed to have a circular shape when viewed from an opening direction of the second communication hole.

6. The head chip according to claim 1, wherein
in an inner surface of the second communication hole, a dimension between portions opposed to each other is twice or more as large as a film thickness of the first protective film to be formed in the jet channel.

7. The head chip according to claim 1, wherein
the jet hole plate is bonded to the intermediate plate via an adhesive, and
a part of the adhesive is housed in the second communication holes.

8. The head chip according to claim 1, further comprising:
a non-jet channel which is formed in a portion located between the jet channels adjacent to each other in the second direction in the actuator plate, and which is not filled with the liquid;
a second electrode formed on an inner surface of the non-jet channel; and
a second protective film disposed so as to cover the second electrode on the inner surface of the non-jet channel, wherein the intermediate plate is provided with a third communication hole communicated with the non-jet channel.

9. The head chip according to claim 8, wherein
the non-jet channel opens on an end surface facing to a first side in the first direction in the actuator plate, and
the third communication hole is communicated with the non-jet channel in an end portion at a second side as an opposite side to the first side in the first direction in the non-jet channel.

10. The head chip according to claim 8, wherein
the non-jet channel includes a protruding part protruding in the first direction from the channel opening part opening on the channel opening surface in the jet channel, and
the third communication hole extends in the second direction traversing between the protruding parts of the non-jet channels adjacent to each other in the second direction, and is collectively communicated with the non-jet channels adjacent to each other through the protruding parts.

11. A liquid jet head comprising the head chip according to claim 1.

12. A liquid jet recording device comprising the liquid jet head according to claim 11.

13. A method of manufacturing a head chip including
an actuator plate in which a plurality of jet channels extending in a first direction is arranged in a second direction crossing the first direction,
a first electrode formed on an inner surface of the jet channel,
a first protective film disposed so as to cover the first electrode on the inner surface of the jet channel, and
an intermediate plate disposed so as to be opposed to a channel opening surface on which the jet channels open in the actuator plate, the method comprising:
a communication hole formation step of forming first communication holes and second communication holes respectively communicated with the plurality of jet channels to the intermediate plate;
a protective film formation step of forming the first protective film in the jet channels through the first communication holes and the second communication holes in a state in which the intermediate plate is stacked on the actuator plate; and
a jet hole plate stacking step of stacking a jet hole plate having a plurality of jet holes configured to jet liquid on the intermediate plate so that the first communication holes are respectively communicated with the jet holes, and the second communication holes are closed with the jet hole plate.

14. The method of manufacturing the head chip according to claim 13, further comprising an intermediate plate stacking step of stacking the intermediate plate on the actuator plate before the protective film formation step, wherein
the communication hole formation step includes
a first communication step of providing the first communication holes to the intermediate plate after the intermediate plate stacking step, and
a second communication step of providing the second communication holes to the intermediate plate before the intermediate plate stacking step.

15. The method of manufacturing the head chip according to claim 13, further comprising an intermediate plate stacking step of stacking the intermediate plate on the actuator plate before the protective film formation step, wherein
the communication hole formation step is performed between the intermediate plate stacking step and the protective film formation step.

16. The method of manufacturing the head chip according to claim 13, wherein
the head chip further includes:
a non-jet channel which includes a protruding part protruding in the first direction from a channel opening part opening on the channel opening surface in the jet channel, and which is formed in a portion located between the jet channels adjacent to each other in the second direction in the actuator plate, and which is not filled with the liquid,
a second electrode formed on an inner surface of the non-jet channel; and
a second protective film disposed so as to cover the second electrode on the inner surface of the non-jet channel, and
the method further comprises:
a third communication step of forming a third communication hole which extends in the second direction traversing between the protruding parts of the non-jet channels adjacent to each other in the second direction in the intermediate plate, and is collectively communicated with the non-jet channels adjacent to each other through the protruding parts; and
an intermediate plate stacking step of stacking the intermediate plate provided with the third communication hole on the actuator plate before the protective film formation step.
